(19) United States
(12) Patent Application Publication
(10) Pub. No.: US 2011/0026617 A1
(43) Pub. Date: Feb. 3, 2011

(54) Method for Estimating Transmission Modes and Lengths of Guard Intervals Using the Guard Intervals of OFDM Symbols

(75) Inventors: Hwang Soo Lee, Daejeon (KR); Moohong Lee, Daejeon (KR); Jeong Han Jeong, Daejeon (KR); Byungjik Keum, Daejeon (KR); Young Serk Shim, Seoul (KR)

Correspondence Address: ABELMAN, FRAYNE & SCHWAB, 666 THIRD AVENUE, 10TH FLOOR, NEW YORK, NY, 10017, US

(73) Assignee: Korea Advanced Institute of Science & Technology

(21) Appl. No.: 12/574,354

(22) Filed: Oct. 6, 2009

(30) Foreign Application Priority Data
Jul. 28, 2009 (KR) 10-2009-0068703

(51) Int. Cl. H04K 1/10; H04L 27/06

(52) U.S. Cl. 375/260; 375/343

(57) ABSTRACT

There is provided a method for effectively estimating transmission modes and lengths of guard intervals in the implementation of an integrated services digital broadcasting-T (ISDB-T) receiver. A method for estimating transmission modes and lengths of guard intervals in a broadcasting system having signals transmitted therein, the signals having a plurality of transmission modes, the transmission modes each having plural kinds of transmission symbols, the transmission symbols in each of the transmission modes having the same length of data intervals and different lengths of guard intervals, the transmission symbols in different transmission modes having different lengths of data intervals and different lengths of guard intervals, the guard interval in each of transmission symbols being obtained by copying a rear section of the data interval in each of the symbols and prefixing the copied rear section to a front section of the data interval, and one of the transmission symbols being periodically repeated, the method comprising: performing correlation while scanning the signals using a plurality of correlation windows respectively corresponding to the plurality of transmission modes; selecting the transmission mode corresponding to the correlation window having an outputted correlation result among the plurality of correlation windows as a transmission mode of a received signal; and estimating a existing time of the correlation result as the length of a guard interval in the received signal.

### CROSS-REFERENCE TO RELATED APPLICATION

This application claims priority to Korean Patent Application No. 2009-68703, filed on Jul. 28, 2009, and all the benefits accruing therefrom under 35 U.S.C. §119, the contents of which in its entirety are herein incorporated by reference.

### BACKGROUND

1. Field

The present relates to a communication method using orthogonal frequency division multiplexing (OFDM) symbols.

2. Description of the Related Art

FIG. 1 illustrates the structure of an orthogonal frequency division multiplexing (OFDM) symbol used in an integrated services digital broadcasting-T (ISDB-T) system.

In the ISDB-T system, there is no separate signal for synchronization, like a phase reference symbol (PRS) in a terrestrial digital multimedia broadcasting (TDMB) system. Therefore, a cyclic prefix (CP) that is a guard interval of an OFDM signal is used to estimate transmission modes and lengths of guard intervals. As illustrated in FIG. 1, the guard interval is obtained by copying a rear section of the OFDM symbol and prefixing the copied rear section to a front section of the OFDM symbol so as to reduce influence of inter-symbol interference (ISI) due to the delay of a signal. Thus, since the content of the guard interval is identical to that of the rear section of the OFDM symbol, the transmission modes and the lengths of the guard intervals are estimated using correlation characteristics.

FIGS. 2a to 2c are schematic views illustrating transmission modes used in the ISDB-T system and OFDM symbols used in each of the transmission modes.

As illustrated in FIGS. 2a to 2c, three modes, i.e., first, second and third transmission modes are used in the ISDB-T system. Further, lengths of four symbols are used for each of the transmission modes. Symbols used in the first transmission mode are illustrated in FIG. 2a, and symbols used in the second transmission mode are illustrated in FIG. 2b. Symbols used in the third transmission mode are illustrated in FIG. 2c.

In four symbols 211, 212, 213 and 214 used in the first transmission mode, the ratios of guard intervals to data intervals are ¼, ⅛, 1/16 and 1/32, respectively. The lengths of data intervals 211-2, 212-2, 213-2 and 214-2 in the respective four symbols 211, 212, 213 and 214 are identical to one another as 252 μs. The lengths of guard intervals 211-1, 212-1, 213-1 and 214-1 in the respective four symbols 211, 212, 213 and 214 are 63 μs, 31.5 μs, 15.75 μs and 7.875 μs, respectively. In the first transmission mode, first to fourth signals 211-3, 212-3, 213-3 and 214-3 are configured by repeating the first to fourth symbols 211, 212, 213 and 214, respectively.

In four symbols 221, 222, 223 and 224 used in the second transmission mode, the ratios of guard intervals to data intervals are ¼, ⅛, 1/16 and 1/32, respectively. The lengths of data intervals 221-2, 222-2, 223-2 and 224-2 in the respective four symbols 221, 222, 223 and 224 are identical to one another as 504 μs. The lengths of guard intervals 221-1, 222-1, 223-1 and 224-1 in the respective four symbols 221, 222, 223 and 224 are 126 μs, 63 μs, 31.5 μs and 15.75 μs, respectively. In the second transmission mode, first to fourth signals 221-3, 222-3, 223-3 and 224-3 are configured by repeating the first to fourth symbols 221, 222, 223 and 224, respectively.

In four symbols 231, 232, 233 and 234 used in the third transmission mode, the ratios of guard intervals to data intervals are ¼, ⅛, 1/16 and 1/32, respectively. The lengths of data intervals 231-2, 232-2, 233-2 and 234-2 in the respective four symbols 231, 232, 233 and 234 are identical to one another as 1008 μs. The lengths of guard intervals 231-1, 232-1, 233-1 and 234-1 in the respective four symbols 231, 232, 233 and 234 are 252 μs, 126 μs, 63 μs and 31.5 μs, respectively. In the third transmission mode, first to fourth signals 231-3, 232-3, 233-3 and 234-3 are configured by repeating the first to fourth symbols 231, 232, 233 and 234, respectively.

FIG. 3 is a block diagram of a conventional ISDB-T receiver 300.

In the structure of the conventional ISDB-T receiver 300, radio frequency (RF) signals transmitted through an RF channel are received by using an antenna. In the received RF signals, only signals of a desired frequency band is converted into signals of an intermediate frequency (IF) band by an RF tuner 301 and then converted into baseband digital signals by an analog-to-digital converter (ADC) 302. The digital signals converted by the ADC 302 are stored in an input buffer 303. Then, a transmission mode and guard interval detector 308 estimates transmission modes and lengths of guard intervals using the digital signals stored in the input buffer 303. Three transmission modes. and four different lengths of guard intervals for each of the transmission modes exist in the ISDB-T system. A transmission mode in which the RF signal is being transmitted and the length of guard internal of the RF signal is determined by calculating correlation using the guard intervals of with respect to all guard intervals of all transmission modes and finding the greatest value among correlation results The following equation represents the process of setting the correlation size per symbol as s_{(M,G)} and evaluating value α_{(M,G)}(d) obtained by performing correlation with respect to K(M,G) symbols.

$${α}_{( M , G )} ( d ) = {\sum }_{k = 0}^{k = {K}_{( M , G )} n = {N}_{( M , G )}^{′}} {\sum }_{n = {N}_{( M , G )}^{′} \cdot k + d}^{k + d + {s}_{( M , G )} - 1} {r}_{n} \cdot {r}_{n + N}^{*} \qquad ( 1 )$$

At this time, value d with which the correlation value α_{(M,G)}(d) becomes the maximum is evaluated while moving the value d one by one with respect to all data samples constituting one frame.

Here, rₙ denotes a sample received in an n-th order on the time axis, and M and G denote a transmission mode and a length of a guard interval, respectively. K_{(M,G)} denotes the number of symbols to be accumulated by performing correlation and may be expressed by N′_{(M,G)}=N_{(M)}+N_{CP(M,G)}, which is the number of samples in one symbol. Here, N_{(M)} denotes the size of fast Fourier transform (FFT) in accordance with a transmission mode, and N_{CP(M,G)} denotes the number of samples in a guard interval in accordance with a transmission mode and a length of the guard interval. s_{(M,G)} denotes an interval at which correlation is to be performed in one symbol. If transmission modes and lengths of guard intervals are estimated by using the aforementioned equation, a time and frequency synchronizer 304 estimates time and frequency offsets. A time and frequency offset compensator 305 compensates for the time and frequency offsets using the time and frequency offsets estimated by the time and frequency synchronizer 304. A symbol demodulator 306 performs data demodulation with respect to signals having compensated time and frequency offsets through an OFDM signal demodulation process. Then, a channel decoder 307 performs a channel decoding process for correcting errors of the demodulated data. As described above, in the conventional ISDB-T system, a large amount of calculation is required to estimate transmission modes and lengths of guard intervals. Therefore, its processing speed is lowered.

### SUMMARY

The present invention provides a method for estimating transmission modes and lengths of guard intervals using guard interval correlation characteristics in orthogonal frequency division multiplexing (OFDM) symbols, which can decrease the amount of calculation as compared with the conventional method.

The present invention also provides a method for estimating transmission modes and length of guard intervals in an integrated services digital broadcasting-T (ISDB-T) system, which can improve its processing speed by decreasing the amount of calculation as compared with the convention method.

In one aspect, there is provided a method for estimating transmission modes and lengths of guard intervals in a broadcasting system having signals transmitted therein, the signals having a plurality of transmission modes, the transmission modes each having plural kinds of transmission symbols, the transmission symbols in each of the transmission modes having the same length of data intervals and different lengths of guard intervals, the transmission symbols in different transmission modes having different lengths of data intervals and different lengths of guard intervals, the guard interval in each of transmission symbols being obtained by copying a rear section of the data interval in each of the symbols and prefixing the copied rear section to a front section of the data interval, and one of the transmission symbols being periodically repeated, the method comprising: performing correlation while scanning the signals using a plurality of correlation windows respectively corresponding to the plurality of transmission modes; selecting the transmission mode corresponding to the correlation window having an outputted correlation result among the plurality of correlation windows as a transmission mode of a received signal; and estimating a maintenance time of the correlation result as the length of a guard interval in the received signal. Accordingly, the amount of calculation is considerably reduced, and therefore, its processing speed is improved.

The correlation window corresponding to the transmission mode may comprise two windows having a width identical to the shortest length of a guard interval in the transmission symbols belonging to the corresponding transmission mode, and the interval between the two windows may be identical to the length of data intervals in the transmission symbols belonging to the corresponding transmission mode. Accordingly, only one correlation window is defined for each of the transmission modes, so that the amount of calculation can be reduced in the estimation of the transmission modes and the lengths of guard intervals.

The correlation window corresponding to the transmission mode may comprise two windows having a width shorter than the shortest length of a guard interval in all the transmission symbols belonging to all the transmission modes, and the interval between the two windows may be identical to the length of data intervals in the transmission symbols belonging to the corresponding transmission mode. Accordingly, windows constituting all the correlation windows have the same width, so that the amount of calculation can be additionally reduced.

The performing of the correlation may comprise calculating a correlation value α_{M}(d) using signal values between the two windows constituting the correlation window through the following equation;

$${α}_{M} ( d ) = {\sum }_{n = {N}_{M}^{′} + d}^{{N}_{M}^{′} + {s}_{M} - 1} {r}_{n} \cdot {r}_{n + {N}_{M}}^{*}$$

Here, rₙ denotes a sample received in an n-th order on the time axis, M denotes a transmission mode, N_{M} denotes a size of fast Fourier transform (FFT) in accordance with a transmission mode, N′_{M} denotes a sum of a size of fast Fourier transform (FFT) in accordance with a transmission mode and a length of the guard interval, and s_{M} denotes an interval at which correlation is to be performed in one symbol. Accordingly, there is provided a signal correlation equation having a small amount of calculation. The existing time of the correlation result may be an interval from when the correlation result is increased up to the maximum value to when the correlation result is a predetermined reference value or less. Accordingly, the existing time of the signal correlation result is specifically defined, so that it can be used as the length of a guard interval.

The broadcasting system may be an integrated services digital broadcasting-T (ISDB-T) system. Accordingly, the present invention is applied to an ISDB-T system. Thus, when estimating transmission modes and lengths of guard intervals, the amount of calculation can be reduced and its speed can be improved.

The transmission mode may comprise first, second and third transmission modes. The width of a first correlation window corresponding to the first transmission mode may comprise two windows having a width of 7.875 μs and an interval between the two windows that is 252 μs. The width of a second correlation window corresponding to the second transmission mode may comprise two windows having a width of 15.75 μs and an interval between the two windows that is 504 s. The width of a third correlation window corresponding to the third transmission mode may comprise two windows having a width of 31.5 μs and an interval between the two windows that is 1008 μs. Accordingly, specific sizes and intervals of windows are provided to apply the present invention to the ISDB-T system.

In another aspect, there is provided an integrated services digital broadcasting-T (ISDB-T) receiver having signals transmitted therein, the signals having a plurality of transmission modes, the transmission modes each having plural kinds of transmission symbols, the transmission symbols in each of the transmission modes having the same length of data intervals and different lengths of guard intervals, the transmission symbols in different transmission modes having different lengths of data intervals and different lengths of guard intervals, the guard interval in each of transmission symbols being obtained by copying a rear section of the data interval in each of the symbols and prefixing the copied rear section to a front section of the data interval, and one of the transmission symbols being periodically repeated, the receiver comprising: a radio frequency (RF) tuner for converting only signals of a desired frequency band into signals of an intermediate frequency (IF) band from received RF signals; an analog-digital converter (ADC) for converting the IF band signals into baseband digital signals; an input buffer for storing the digital signals; a transmission mode detector for performing correlation while scanning the signals using a plurality of correlation windows respectively corresponding to the plurality of transmission modes and selecting the transmission mode corresponding to the correlation window having an outputted correlation result among the plurality of correlation windows as a transmission mode of a received signal; a guard interval detector for estimating a existing time of the correlation result as the length of a guard interval in the received signal; a transmission mode and guard interval identifier for identifying whether or not the result estimated through correlation characteristics of the guard interval using information on the transmission mode and the length of the guard interval; a time and frequency synchronizer for estimating time and frequency offsets with respect to the signal in which the transmission mode and the length of guard interval are estimated; a time and frequency offset compensator for compensating for the estimated time and frequency offsets; a symbol demodulator for demodulating the signal having the compensated time and frequency offsets; and a channel decoder for performing channel decoding with respect to the demodulated signal. Accordingly, the amount of calculation is considerably reduced, and therefore, its processing speed is improved.

The correlation window corresponding to the transmission mode may comprise two windows having a width identical to the shortest length of a guard interval in the transmission symbols belonging to the corresponding transmission mode, and the interval between the two windows may be identical to the length of data intervals in the transmission symbols belonging to the corresponding transmission mode. Accordingly, only one correlation window is defined for each of the transmission modes, so that the amount of calculation can be reduced in the estimation of the transmission modes and the lengths of guard intervals.

The correlation window corresponding to the transmission mode may comprise two windows having a width shorter than the shortest length of a guard interval in all the transmission symbols belonging to all the transmission modes, and the interval between the two windows may be identical to the length of data intervals in the transmission symbols belonging to the corresponding transmission mode. Accordingly, windows constituting all the correlation windows have the same width, so that the amount of calculation can be additionally reduced.

The performing of the correlation may comprise calculating a correlation value α_{M}(d) using signal values between the two windows constituting the correlation window through the following equation;

$${α}_{M} ( d ) = {\sum }_{n = {N}_{M}^{′} + d}^{{N}_{M}^{′} + {s}_{M} - 1} {r}_{n} \cdot {r}_{n + {N}_{M}}^{*}$$

Here, rₙ denotes a sample received in an n-th order on the time axis, M denotes a transmission mode, N_{M} denotes a size of fast Fourier transform (FFT) in accordance with a transmission mode, N′_{M} denotes a sum of a size of fast Fourier transform (FFT) in accordance with a transmission mode and a length of the guard interval, and s_{M} denotes an interval at which correlation is to be performed in one symbol. Accordingly, there is provided a signal correlation equation having a small amount of calculation.

The existing time of the correlation result may be an interval from when the correlation result is increased up to the maximum value to when the correlation result is a predetermined reference value or less. Accordingly, the existing time of the signal correlation result is specifically defined, so that it can be used as the length of a guard interval.

The transmission mode may comprise first, second and third transmission modes. The width of a first correlation window corresponding to the first transmission mode may comprise two windows having a width of 7.875 μs and an interval between the two windows that is 252 μs. The width of a second correlation window corresponding to the second transmission mode may comprise two windows having a width of 15.75 μs and an interval between the two windows that is 504 μs. The width of a third correlation window corresponding to the third transmission mode may comprise two windows having a width of 31.5 μs and an interval between the two windows that is 1008 μs. Accordingly, specific sizes and intervals of windows are provided to apply the present invention to the ISDB-T system.

### BRIEF DESCRIPTION OF THE DRAWINGS

The above and other aspects, features and advantages of the disclosed exemplary embodiments will be more apparent from the following detailed description taken in conjunction with the accompanying drawings in which:

FIG. 1 is a view illustrating the structure of an orthogonal frequency division multiplexing (OFDM) symbol used in an integrated services digital broadcasting-T (ISDB-T) system;

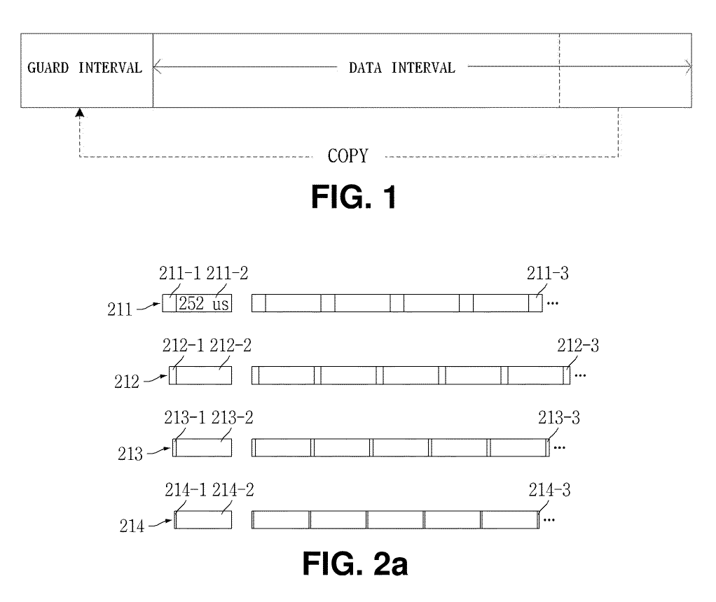

FIGS. 2a to 2c are schematic views illustrating transmission modes used in the ISDB-T system and OFDM symbols used in each of the transmission modes;

FIG. 3 is a block diagram of a conventional ISDB-T receiver;

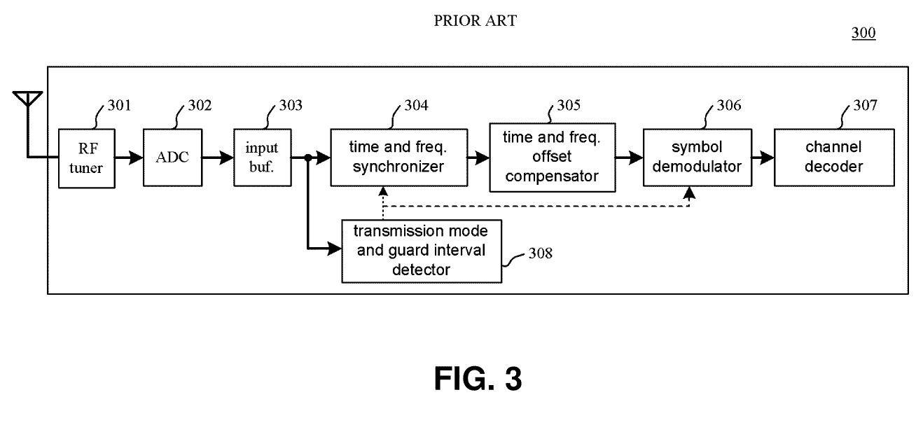

FIG. 4 is a block diagram of an ISDB-T receiver according to an embodiment of the present invention;

FIG. 5 is a view illustrating correlation windows used in a method for estimating a transmission mode and a length of a guard interval in an ISDB-T system according to an embodiment of the present invention;

FIG. 6 is a view illustrating correlation results; and

FIG. 7 is a view illustrating correlation windows used in a modification of the present invention.

### DETAILED DESCRIPTION

Hereinafter, exemplary embodiments of the present invention will be described with reference to the accompanying drawings.

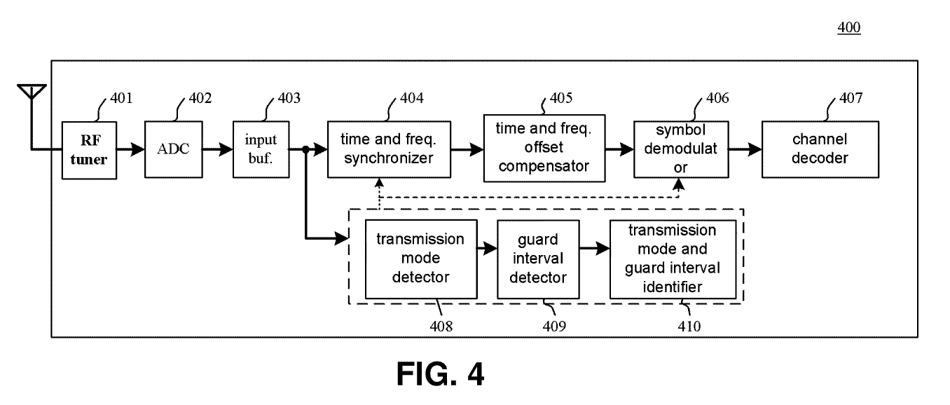

FIG. 4 is a block diagram of an integrated services digital broadcasting-T (ISDB-T) receiver 400 according to an embodiment of the present invention.

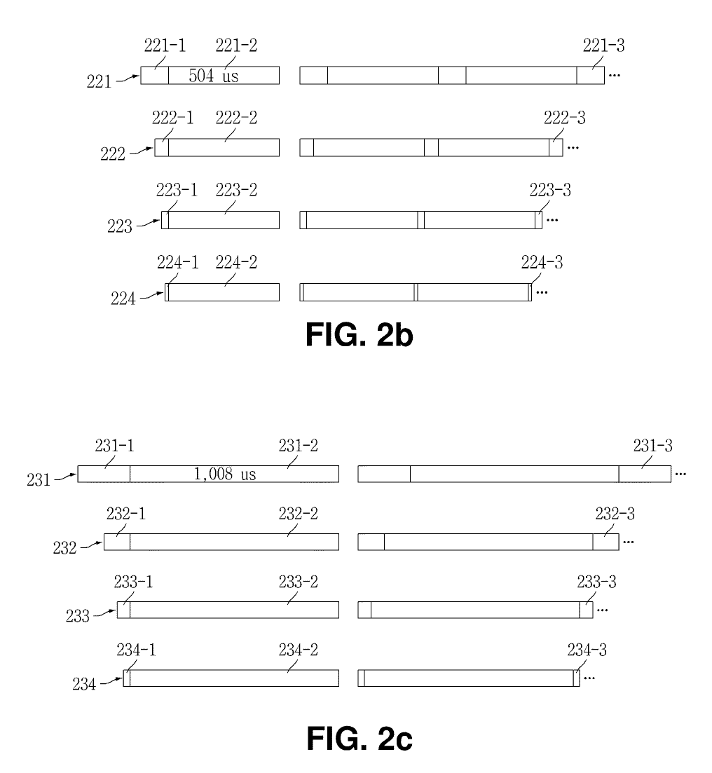

In radio frequency (RF) signals (i.e., ISDB-T signals) received through an RF channel, only signals of a desired frequency band are frequency down-converted to an intermediate frequency (IF) band by an RF tuner 401. The IF band signals is converted into baseband digital signals by an analog-to-digital converter (ADC) 402. The converted baseband digital signals are stored in an input buffer 403 and then transmitted to a transmission mode detector 408 and a time and frequency synchronizer 404. The transmission mode detector 408 estimates transmission modes of the ISDB-T signals received by the ISDB-T receiver 400. As described with reference to FIGS. 2a to 2c, the ISDB-T signals have three transmission modes.

In four symbols 211, 212, 213 and 214 used in a first transmission mode, the ratios of guard intervals to data intervals are ¼, ⅛, 1/16 and 1/32, respectively. The lengths of data intervals 211-2, 212-2, 213-2 and 214-2 in the respective four symbols 211, 212, 213 and 214 are identical to one another as 252 μs. The lengths of guard intervals 211-1, 212-1, 213-1 and 214-1 in the respective four symbols 211, 212, 213 and 214 are 63 μs, 31.5 μs, 15.75 μs and 7.875 μs, respectively. In the first transmission mode, first to fourth signals 211-3, 212-3, 213-3 and 214-3 are configured by repeating the first to fourth symbols 211, 212, 213 and 214, respectively.

In four symbols 221, 222, 223 and 224 used in a second transmission mode, the ratios of guard intervals to data intervals are ¼, ⅛, 1/16 and 1/32, respectively. The lengths of data intervals 221-2, 222-2, 223-2 and 224-2 in the respective four symbols 221, 222, 223 and 224 are identical to one another as 504 μs. The lengths of guard intervals 221-1, 222-1, 223-1 and 224-1 in the respective four symbols 221, 222, 223 and 224 are 126 μs, 63 μs, 31.5 μs and 15.75 μs, respectively. In the second transmission mode, first to fourth signals 221-3, 222-3, 223-3 and 224-3 are configured by repeating the first to fourth symbols 221, 222, 223 and 224, respectively.

In four symbols 231, 232, 233 and 234 used in a third transmission mode, the ratios of guard intervals to data intervals are ¼, ⅛, 1/16 and 1/32, respectively. The lengths of data intervals 231-2, 232-2, 233-2 and 234-2 in the respective four symbols 231, 232, 2323 and 234 are identical to one another as 1008 μs. The lengths of guard intervals 231-1, 232-1, 233-1 and 234-1 in the respective four symbols 231, 232, 233 and 234 are 252 μs, 126 μs, 63 μs and 31.5 μs, respectively. In the third transmission mode, first to fourth signals 231-3, 232-3, 233-3 and 234-3 are configured by repeating the first to fourth symbols 231, 232, 233 and 234, respectively.

Although the ISDB-T system having such specs has been described in this specification, the present invention is not applied to only the ISDB-T system having such specs. For example, the number of transmission modes may be three or more, and the lengths of data intervals and guard intervals in each of the transmission modes do not necessarily have the same values as the aforementioned values. That is, the aforementioned values are limited to help easy understanding of the present invention, and the present invention is not limited by such values. This patent is intended to include the scope having the technical spirit of the present invention defined by the following detailed description and claims.

The transmission mode detector 408 estimates transmission modes of the ISDB-T signals received by the ISDB-T receiver 400, using correlation windows having the same widths as those of the shortest guard intervals 214-1, 224-1 and 234-1 in the respective transmission modes. Accordingly, the amount of calculation necessary for estimating transmission modes is reduced. In such a method, although the lengths of guard intervals are different from one another, the lengths of OFDM data symbol intervals in each of the transmission modes are identical to one another. Hence, the correlation characteristics are maintained.

A guard interval detector 409 estimates lengths of guard intervals in symbols constituting the received signals, using the estimated results for transmission modes.

A transmission mode and guard interval identifier 410 identifies whether or the estimated results are correct, using information on the estimated transmission modes and the lengths of the guard intervals. By using such a method, the amount of calculation is considerably reduced as compared with the conventional method.

If the estimation of the transmission modes and the lengths of the guard intervals is finished, the time and frequency synchronizer 404 estimates time and frequency offsets.

A time and frequency offset compensator 405 compensates for time and frequency offsets of the received signals, using the estimated results of the time and frequency synchronizer 404.

A symbol demodulator 406 demodulates the signals having time and frequency offsets compensated by the time and frequency offset compensator 405 through a demodulation process.

A channel decoder 407 performs channel decoding with respect to the signals demodulated by the symbol demodulator 406. Therefore, data errors are corrected in the demodulated signals.

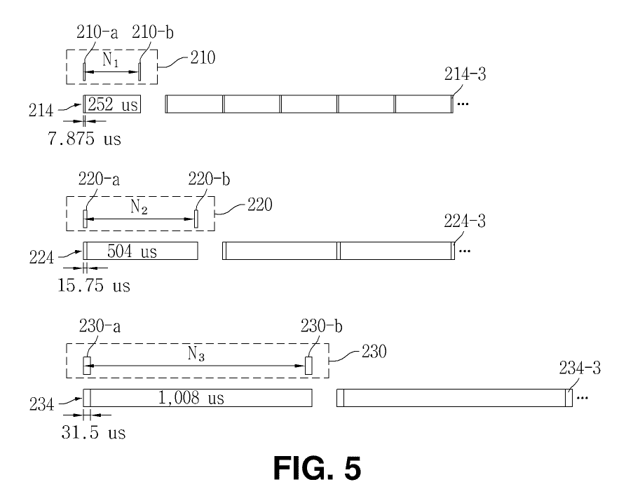

FIG. 5 is a view illustrating a method for estimating a transmission mode and a length of a guard interval, performed in the transmission mode detector 408 and the guard interval detector 409.

In FIG. 5, symbols 214, 224 and 234 are the fourth symbols 214, 224 and 234 in the first, second and third modes, described with reference to FIGS. 2a to 2c, respectively. That is, the three symbols 214, 224 and 234 illustrated in FIG. 5 are symbols with the shortest guard intervals in the respective transmission modes of the ISDB-T system. The signals 214-3, 224-3 and 234-3 are signals having the symbols 214, 224 and 234, respectively.

In the present invention, transmission modes are estimated by using correlation windows 210, 220 and 230 illustrated in FIG. 5. The correlation windows 210, 220 and 230 are only tools for defining a calculation method so as to illustrate the method for estimating transmission modes and lengths of guard intervals according to the present invention. The correlation windows 210, 220 and 230 do not necessarily exist in a program code or processor for estimating transmission modes and lengths of guard intervals. Although the correlation windows 210, 220 and 230 do not exist in the program code or processor, it is construed that the calculation method used in the program code or processor for estimating transmission modes and lengths of guard intervals is included in the scope of the present invention when it has the same spirit as that of the present invention.

Each of the correlation windows 210, 220 and 230 comprises two windows having the same width as the length of the guard interval in the symbol having the shortest length of the guard interval in each of the first, second and third transmission modes. Each of the two windows belongs to each of the correlation windows 210, 220 and 230 has the same interval as the length of the data interval in the symbol having the shortest length of the guard interval in each of the first, second and third transmission modes.

Specifically, the width of windows 210-a and 210-b constituting the first correlation window 210 is identical to the length of the guard interval in a symbol having the shortest guard interval among a plurality of symbols in the first transmission mode, and the interval N₁ between the two windows 210-a and 210-b is identical to the length of the data interval in the first transmission mode. That is, the width of the windows 210-a and 210-b constituting the first correlation window 210 is 7.875 μs, and the interval N₁ between the two windows 210-a and 210-b is 252 μs.

The widths of windows 220-a and 220-b constituting the second correlation window 220 is identical to the length of the guard interval in a symbol having the shortest guard interval among a plurality of symbols in the second transmission mode, and the interval N₂ between the two windows 220-a and 220-b is identical to the length of the data interval in the second transmission mode. That is, the width of the windows 220-a and 220-b constituting the second correlation window 220 is 15.75 μs, and the interval N₂ between the two windows 220-a and 220-b is 504 μs.

The widths of windows 230-a and 230-b constituting the third correlation window 230 is identical to the length of the guard interval in a symbol having the shortest guard interval among a plurality of symbols in the third transmission mode, and the interval N₃ between the two windows 230-a and 230-b is identical to the length of the data interval in the third transmission mode. That is, the width of the windows 230-a and 230-b constituting the third correlation window 230 is 31.5 μs, and the interval N₃ between the two windows 230-a and 230-b is 1008 μs.

While scanning signals inputted to the transmission mode detector 408 using the correlation windows defined as described above, a correlation value α_{M}(d) is calculated with respect to a signal value between two windows constituting each of the correlation windows 210, 220 and 230. The aforementioned procedure may be expressed by the following Equation 2.

$${α}_{M} ( d ) = {\sum }_{n = {N}_{M}^{′} + d}^{{N}_{M}^{′} + {s}_{M} - 1} {r}_{n} \cdot {r}_{n + {N}_{M}}^{*} \qquad ( 2 )$$

Here, rₙ denotes a sample received in an n-th order on the time axis, and M denotes a transmission mode. N_{M} denotes a size of fast Fourier transform (FFT) in accordance with a transmission mode, N′_{M} denotes a sum of a size of fast Fourier transform (FFT) in accordance with a transmission mode and a length of the guard interval, and s_{M} denotes an interval at which correlation is to be performed in one symbol.

Although the lengths of guard intervals are different from one another in the same transmission mode, the lengths of OFDM data intervals are identical to one another. Hence, the correlation characteristics are obtained by assuming that the shortest guard interval ( 1/32) is used. The correlation result value is high only in the same transmission mode, and the correlation result value is low in the other transmission modes.

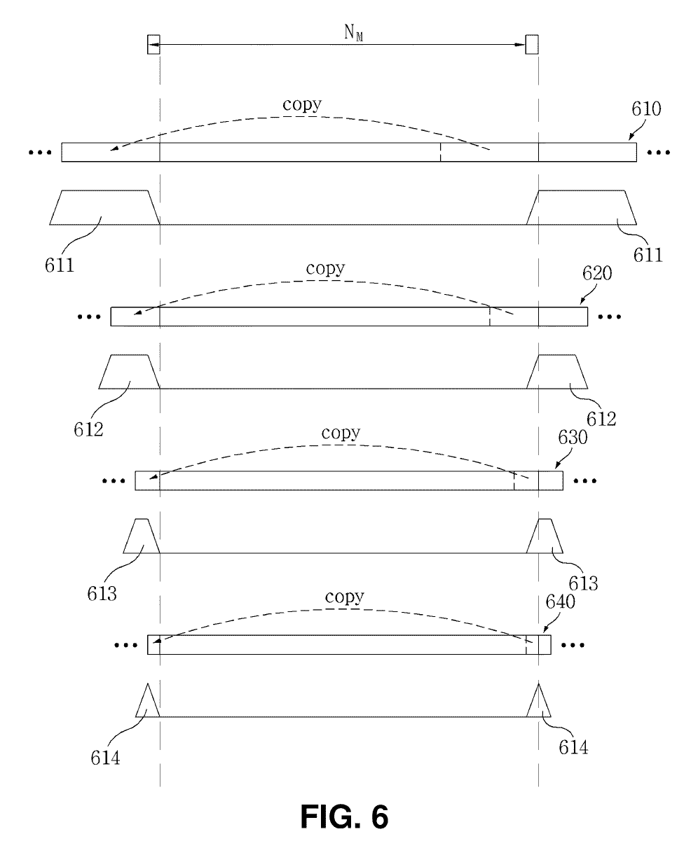

FIG. 6 is a view illustrating correlation results obtained by performing correlation with respect to signals having difference lengths of guard intervals belonging to any one of first to third transmission modes, using correlation window corresponding to the transmission mode. That is, signals 610, 620, 630 and 640 have lengths of data intervals, identical to one another, and have lengths of guard intervals, different from one another.

The ratio of the length of a guard interval to the length of a data interval in the signal 610 is ¼, and the ratio of the length of a guard interval to the length of a data interval in the signal 620 is ⅛. The ratio of the length of a guard interval to the length of a data interval in the signal 630 is 1/16, and the ratio of the length of a guard interval to the length of a data interval in the signal 640 is 1/32.

If the signals 610, 620, 630 and 640 of FIG. 6 are signals in the first transmission mode, correlation values 611, 612, 613 and 614 having a predetermined value or more are outputted as illustrated in FIG. 6 only when the correlation is performed by using the first correlation window 210. When the correlation is performed by using the other correlation windows 220 and 230, the correlation values 611, 612, 613 and 614 having the predetermined value or more are not outputted. Similarly, if the signals 610, 620, 630 and 640 of FIG. 6 are signals in the second transmission mode, the correlation values 611, 612, 613 and 614 having the predetermined value or more are outputted as illustrated in FIG. 6 only when the correlation is performed by using the second correlation window 220. When the correlation is performed by using the other correlation windows 210 and 230, the correlation values 611, 612, 613 and 614 having the predetermined value or more are not outputted. Similarly, if the signals 610, 620, 630 and 640 of FIG. 6 are signals in the third transmission mode, the correlation values 611, 612, 613 and 614 having the predetermined value or more are outputted as illustrated in FIG. 6 only when the correlation is performed by using the third correlation window 220. When the correlation is performed by using the other correlation windows 210 and 220, the correlation values 611, 612, 613 and 614 having the predetermined value or more are not outputted.

Through such characteristics, correlations are performed with respect to signals received by the transmission mode detector 408 using the respective first, second and third correlation windows 210, 220 and 230, so that transmission modes of the received signals can be detected.

In the correlation result, any one of the four correlation results 611, 612, 613 and 614 is outputted depending on whether ‘the length of a guard interval/the length of a data interval’ in each of the received signals is ¼, ⅛, 1/16 or 1/32. If ‘the length of a guard interval/the length of a data interval’ is ¼, the width of the outputted correlation result 611 corresponds to the longest length of a guard interval in the corresponding transmission mode. Similarly, if ‘the length of a guard interval/the length of a data interval’ is ⅛, the width of the outputted correlation result 612 corresponds to the second longest length of a guard interval in the corresponding transmission mode. Similarly, if ‘the length of a guard interval/the length of a data interval’ is 1/16, the width of the outputted correlation result 613 corresponds to the third longest length of a guard interval in the corresponding transmission mode. Similarly, if ‘the length of a guard interval/the length of a data interval’ is 1/32, the width of the outputted correlation result 614 corresponds to the fourth longest length of a guard interval in the corresponding transmission mode.

That is, existing times of the correlation results 611, 612, 613 and 614 have four cases in accordance with lengths of guard intervals for each of the transmission modes, as illustrated in FIG. 6. Thus, the length of a guard interval can be estimated depending on whether each of the correlation results corresponds to any one of the four cases.

For example, the existing time of the maximum value in a correlation result, i.e., the interval from when the correlation result is increased up to the maximum value to when the correlation result is a predetermined reference value or less, may be estimated as the length of a guard interval. At this time, the reference value may be determined by arbitrarily selecting a value with which two signals subjected to correlation calculation are not correlated with each other.

### MODIFICATION OF THE INVENTION

In the aforementioned embodiment, it has been described that the width of the windows constituting each of the first, second and third correlation windows 210, 220 and 230 is identical to the shortest length of a guard interval in each of the transmission modes, and the interval N₂ between two windows is identical to the length of a data interval in each of the transmission mode.

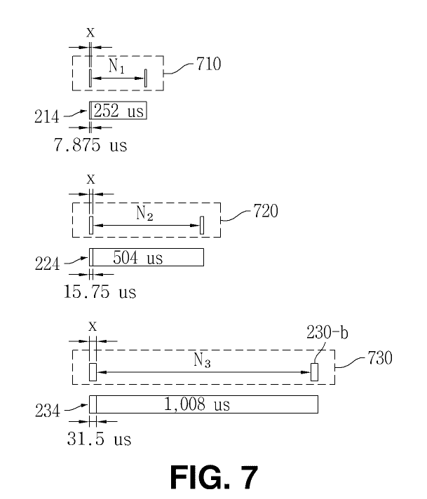

On the other hand, in the first modification, the widths of windows constituting first, second and third correlation window 710, 720 and 730 are shorter than the shortest length of the guard interval 214-1 throughout all the transmission modes, as illustrated in FIG. 7. Here, the widths of windows constituting the respective first, second and third correlation window 710, 720 and 730 are identical to one another. That is, the size of windows constituting each of the first, second and third correlation windows 710, 720 and 730 may be 7.875 μs or a value smaller than 7.875 μs.

While the exemplary embodiments have been shown and described, it will be understood by those skilled in the art that various changes in form and details may be made thereto without departing from the spirit and scope of this disclosure as defined by the appended claims. In addition, many modifications can be made to adapt a particular situation or material to the teachings of this disclosure without departing from the essential scope thereof. Therefore, it is intended that this disclosure not be limited to the particular exemplary embodiments disclosed as the best mode contemplated for carrying out this disclosure, but that this disclosure will include all embodiments falling within the scope of the appended claims. Although the ISDB-T system has been described as an example of the present invention, the present invention is not necessarily applied to only the ISDB-T system. The present invention may be variously applied in communication schemes in which a copied portion of a data interval is used as a guard interval. Although it has been described in the present invention that the number of transmission modes is three and the number of lengths of guard intervals in each of the transmission modes is four, such numbers are provided only for illustrative purposes.

What is claimed is:

1. A method for estimating transmission modes and lengths of guard intervals in a broadcasting system having signals transmitted therein, the signals having a plurality of transmission modes, the transmission modes each having plural kinds of transmission symbols, the transmission symbols in each of the transmission modes having the same length of data intervals and different lengths of guard intervals, the transmission symbols in different transmission modes having different lengths of data intervals and different lengths of guard intervals, the guard interval in each of transmission symbols being obtained by copying a rear section of the data interval in each of the symbols and prefixing the copied rear section to a front section of the data interval, and one of the transmission symbols being periodically repeated, the method comprising:
performing correlation while scanning the signals using a plurality of correlation windows respectively corresponding to the plurality of transmission modes;
selecting the transmission mode corresponding to the correlation window having an outputted correlation result among the plurality of correlation windows as a transmission mode of a received signal; and
estimating a existing time of the correlation result as the length of a guard interval in the received signal.

2. The method according to claim 1, wherein the correlation window corresponding to the transmission mode comprises two windows having a width identical to the shortest length of a guard interval in the transmission symbols belonging to the corresponding transmission mode, and the interval between the two windows is identical to the length of data intervals in the transmission symbols belonging to the corresponding transmission mode.

3. The method according to claim 1, wherein the correlation window corresponding to the transmission mode comprises two windows having a width shorter than the shortest length of a guard interval in all the transmission symbols belonging to all the transmission modes, and the interval between the two windows is identical to the length of data intervals in the transmission symbols belonging to the corresponding transmission mode.

4. The method according to claim 2, wherein the performing of the correlation comprises calculating a correlation value α_{M}(d) using signal values between the two windows constituting the correlation window through the following equation;
$${α}_{M} ( d ) = {\sum }_{n = {N}_{M}^{′} + d}^{{N}_{M}^{′} + {s}_{M} - 1} {r}_{n} \cdot {r}_{n + {N}_{M}}^{*}$$
wherein rₙ denotes a sample received in an n-th order on the time axis, M denotes a transmission mode, N_{M} denotes a size of fast Fourier transform (FFT) in accordance with a transmission mode, N′_{M} denotes a sum of a size of fast Fourier transform (FFT) in accordance with a transmission mode and a length of the guard interval, and s_{M} denotes an interval at which correlation is to be performed in one symbol.

5. The method according to claim 1, wherein the existing time of the correlation result is an interval from when the correlation result is increased up to the maximum value to when the correlation result is a predetermined reference value or less.

6. The method according to claim 1, wherein the broadcasting system is an integrated services digital broadcasting-T (ISDB-T) system.

7. The method according to claim 6, wherein:
the transmission mode comprises first, second and third transmission modes;
the width of a first correlation window corresponding to the first transmission mode comprises two windows having a width of 7.875 μs and an interval between the two windows that is 252 μs;
the width of a second correlation window corresponding to the second transmission mode comprises two windows having a width of 15.75 μs and an interval between the two windows that is 504 μs; and
the width of a third correlation window corresponding to the third transmission mode comprises two windows having a width of 31.5 μs and an interval between the two windows that is 1008 μs.

8. An integrated services digital broadcasting-T (ISDB-T) receiver having signals transmitted therein, the signals having a plurality of transmission modes, the transmission modes each having plural kinds of transmission symbols, the transmission symbols in each of the transmission modes having the same length of data intervals and different lengths of guard intervals, the transmission symbols in different transmission modes having different lengths of data intervals and different lengths of guard intervals, the guard interval in each of transmission symbols being obtained by copying a rear section of the data interval in each of the symbols and prefixing the copied rear section to a front section of the data interval, and one of the transmission symbols being periodically repeated, the receiver comprising:
a radio frequency (RF) tuner for converting only signals of a desired frequency band into signals of an intermediate frequency (IF) band from received RF signals;
an analog-digital converter (ADC) for converting the IF band signals into baseband digital signals;
an input buffer for storing the digital signals;
a transmission mode detector for performing correlation while scanning the signals using a plurality of correlation windows respectively corresponding to the plurality of transmission modes and selecting the transmission mode corresponding to the correlation window having an outputted correlation result among the plurality of correlation windows as a transmission mode of a received signal;
a guard interval detector for estimating a existing time of the correlation result as the length of a guard interval in the received signal;
a transmission mode and guard interval identifier for identifying whether or not the result estimated through correlation characteristics of the guard interval using information on the transmission mode and the length of the guard interval;
a time and frequency synchronizer for estimating time and frequency offsets with respect to the signal in which the transmission mode and the length of guard interval are estimated;
a time and frequency offset compensator for compensating for the estimated time and frequency offsets;
a symbol demodulator for demodulating the signal having the compensated time and frequency offsets; and
a channel decoder for performing channel decoding with respect to the demodulated signal.

9. The ISDB-T receiver according to claim 8, wherein the correlation window corresponding to the transmission mode comprises two windows having a width identical to the shortest length of a guard interval in the transmission symbols belonging to the corresponding transmission mode, and the interval between the two windows is identical to the length of data intervals in the transmission symbols belonging to the corresponding transmission mode.

10. The ISDB-T receiver according to claim 8, wherein the correlation window corresponding to the transmission mode comprises two windows having a width shorter than the shortest length of a guard interval in all the transmission symbols belonging to all the transmission modes, and the interval between the two windows is identical to the length of data intervals in the transmission symbols belonging to the corresponding transmission mode.

11. The ISDB-T receiver according to claim 9, wherein the performing of the correlation comprises calculating a correlation value α_{M}(d) using signal values between the two windows constituting the correlation window through the following equation;
$${α}_{M} ( d ) = {\sum }_{n = {N}_{M}^{′} + d}^{{N}_{M}^{′} + {s}_{M} - 1} {r}_{n} \cdot {r}_{n + {N}_{M}}^{*}$$
wherein rₙ denotes a sample received in an n-th order on the time axis, M denotes a transmission mode, N_{M} denotes a size of FFT in accordance with a transmission mode, N′_{M} denotes a sum of a size of fast Fourier transform (FFT) in accordance with a transmission mode and a length of the guard interval, and s_{M} denotes an interval at which correlation is to be performed in one symbol.

12. The ISDB-T receiver according to claim 8, wherein the existing time of the correlation result is an interval from when the correlation result is increased up to the maximum value to when the correlation result is a predetermined reference value or less.

13. The ISDB-T receiver according to claim 8, wherein:
the transmission mode comprises first, second and third transmission modes;
the width of a first correlation window corresponding to the first transmission mode comprises two windows having a width of 7.875 μs and an interval between the two windows that is 252 μs;
the width of a second correlation window corresponding to the second transmission mode comprises two windows having a width of 15.75 μs and an interval between the two windows that is 504 μs; and
the width of a third correlation window corresponding to the third transmission mode comprises two windows having a width of 31.5 μs and an interval between the two windows that is 1008 μs.

14. The method according to claim 3, wherein the performing of the correlation comprises calculating a correlation value α_{M}(d) using signal values between the two windows constituting the correlation window through the following equation;
$${α}_{M} ( d ) = {\sum }_{n = {N}_{M}^{′} + d}^{{N}_{M}^{′} + {s}_{M} - 1} {r}_{n} \cdot {r}_{n + {N}_{M}}^{*}$$
wherein rₙ denotes a sample received in an n-th order on the time axis, M denotes a transmission mode, N_{M} denotes a size of fast Fourier transform (FFT) in accordance with a transmission mode, N′_{M} denotes a sum of a size of fast Fourier transform (FFT) in accordance with a transmission mode and a length of the guard interval, and s_{M} denotes an interval at which correlation is to be performed in one symbol.

15. The ISDB-T receiver according to claim 10, wherein the performing of the correlation comprises calculating a correlation value α_{M}(d) using signal values between the two windows constituting the correlation window through the following equation;
$${α}_{M} ( d ) = {\sum }_{n = {N}_{M}^{′} + d}^{{N}_{M}^{′} + {s}_{M} - 1} {r}_{n} \cdot {r}_{n + {N}_{M}}^{*}$$
wherein rₙ denotes a sample received in an n-th order on the time axis, M denotes a transmission mode, N_{M} denotes a size of FFT in accordance with a transmission mode, N′_{M} denotes a sum of a size of fast Fourier transform (FFT) in accordance with a transmission mode and a length of the guard interval, and s_{M} denotes an interval at which correlation is to be performed in one symbol.
